(19) United States
(12) Patent Application Publication
(10) Pub. No.: US 2015/0006346 A1
(43) Pub. Date: Jan. 1, 2015

(54) ACCOUNT ENGINE WITH MODULAR SERVICES AND ACCESS CHANNELS

(71) Applicant: Quisk, Inc., Sunnyvale, CA (US)

(72) Inventors: Praveen Amancherla, Cupertino, CA (US); Kumar Kartikeya, Cupertino, CA (US)

(73) Assignee: QUISK, INC., Sunnyvale, CA (US)

(21) Appl. No.: 14/162,303

(22) Filed: Jan. 23, 2014

Related U.S. Application Data
(60) Provisional application No. 61/841,114, filed on Jun. 28, 2013.

(51) Int. Cl. G06Q 40/02

(52) U.S. Cl. CPC G06Q 40/02
USPC 705/35

(57) ABSTRACT

A service request having an external format is received by a server. The service request is translated from the external channel format into a common internal system format using a discrete adaptor for that external channel format. The service request is then applied to a service lookup table to lookup a service address. The service lookup table is updated by adding an entry to the lookup up table. When in the internal system format, the header of the request uses an identical nomenclature as the service lookup table to identify the requested service. At least part of the application of the service request to the lookup table and the update of the service lookup table can occur simultaneously.

### CROSS-REFERENCE TO RELATED APPLICATIONS

This application claims the benefit of U.S. Provisional Application No. 61/841,114, filed Jun. 28, 2013, the contents of which are hereby incorporated by reference.

### BACKGROUND

Financial institutions and payment service providers are continuously increasing both the array of account services and the degrees of access to those account services that they provide to their customers. As a result, their customers expect to be able to access accounts through an increasing number of channels such as web portals, automated teller machines (ATMs), interactive voice response (IVR) systems, text messaging (SMS) interfaces, and mobile phone applications. They also expect to have access to their accounts through these diverse channels at any time, such that outage periods due to maintenance or upgrades are considered intolerably inconvenient. Furthermore, payment service providers commonly have a global presence, so there is no time of the day or night when a payment service can be shut down without disrupting a key point in the business day somewhere in the world.

As a result of the increasingly stringent consumer demands and global reach of most modern payment systems, it is becoming increasingly difficult to add additional services or access channels to a payment service without interrupting the flow of the payment service. A traditional method of updating a service offered electronically via a network is to schedule downtime for servers that are offering the service, push an updated version of the service to the servers, and restart the system to effectuate the updated version. The push can include information on how to process service requests from an additional channel or information on how to process requests for new kinds of services. For example, a new version of a payment system may include information on how to translate and process a request from an SMS device or it may include information on how to process a balance inquiry and return a value for the account's balance via the channel on which the request was received.

More sophisticated methods for updating an account management system utilize a router to route service requests or a load balancer to spoof a service request during the upgrading process. Routers are able to route different service requests to an appropriate location in the server's memory in order for the proper service to be delivered. A system that uses a service broker can limit the amount of downtime associated with an update because the code for the entire system does not have to be pushed to the server. Instead, only the service broker and the new service module need to be added to the server, thus limiting the amount of time during which the server will be out of commission.

The use of spoofing can also alleviate problems associated with updating a payment system. Spoofing requires the use of additional hardware, but has the potential to completely eliminate system downtime. An additional server is introduced to the system that is not currently processing service request, but is instead standing by with the updated version of the system. When it is time to update, a load balancer or other network device can begin to automatically reroute requests that were intended for the original server over to the additional server such that the system appears to have been immediately updated. While the requests are being rerouted, the original server can receive a code push for the new version of the payment system. At this point, the forwarding network device can cease forwarding requests and allow them to pass through to the original server. An intended result of this procedure is that the parties requesting services rarely experience any disruption in service while the upgraded version of the system can be deployed as soon as it is ready.

### SUMMARY

Disclosed herein are systems, methods, and computer-readable media for an account engine with modular services and access channels. The systems can perform the described methods and can be stored on the computer-readable media.

An account management system can include a set of discrete adaptors instantiated on a server. Each of the discrete adaptor can have a dedicated uniform resource locator and can receive a stream of service requests in an external channel format. The external channel format can be specific to the discrete adaptor. Each of the discrete adaptors can translate the service requests from the external channel format to normalized service requests in a common internal system format. The account management system can include a service broker layer that receives the normalized service requests in the common internal system format and parses the normalized service request for service request lookup data to lookup in a service lookup table. The account management system can include a code repository storing (i) code for a new discrete adaptor, and (ii) a new entry for the service lookup table and corresponding to the new discrete adaptor.

The account management system can further allow updating of the service lookup table by adding an entry to the service lookup table. The common internal system format and the service lookup table format can use an identical nomenclature to identify the service. The account management system allows for concurrency such that at least part of the applying step and at least part of the updating step can occur simultaneously.

A computer-implemented method can include a step of receiving a service request using a discrete adaptor. The service request has an external channel format that is specific to the discrete adaptor. The service request requests a service. The discrete adaptor is instantiated on a server. The method can also include the step of translating the service request from the external channel format into a common internal system format using the discrete adaptor. The discrete adaptor is dedicated to the specific external channel on which the service request was received. The method can also include the step of parsing the service request in the common internal system format in a service broker layer to obtain service request lookup data from the service request. The method can also include the step of looking up the service request lookup data in a service lookup table to retrieve a service address. The method can also include the step of updating the service lookup table by adding an entry to the service request lookup table. The entry has a service lookup table format. At least part of the lookup step and at least part of the updating step occur simultaneously. The common internal system format and the service lookup table format use an identical nomenclature to identify the service

### BRIEF DESCRIPTION OF DRAWINGS

FIG. 1 illustrates a block diagram of a system for adding a backend service and access channel to an account engine in accordance with one or more embodiments.

FIG. 2 illustrates a flow chart of a method for adding a backend service to an account engine in accordance with one or more embodiments.

FIG. 3a illustrates a format for a service broker entry in accordance with one or more embodiments.

FIG. 3b illustrates a format for a normalized service request in accordance with one or more embodiments.

FIG. 4 illustrates a block diagram of a system with modular security in accordance with one or more embodiments.

FIG. 5 illustrates a flow chart of a method for processing requests sent to a security layer.

### DETAILED DESCRIPTION

Reference now will be made in detail to one or more embodiments of the disclosed invention(s), one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used with another embodiment to yield a still further embodiment. Thus, it is intended that the present subject matter covers all such modifications and variations within the scope of the appended claims and their equivalents.

The disclosure relates generally to providing services in response to network service requests, and more specifically to account engines that provide back end account management services via a network. The ability of a network service provider to provide services in response to requests in a reliable and uninterrupted manner has become the expected status quo. However, network service providers are also modifying the services they offer at a continuously increasing rate. As described above, current methods and systems for increasing the channels for accessing online services and the array of services offered by networked systems have notable drawbacks. Spoofing service request by routing them to additional services is not optimal because it requires additional hardware. Adding additional channels for accessing a system generally requires a complete rework of the services themselves and at the very least requires a period of network downtime while an additional API is added to the system. Using a service broker to route requests to additional systems makes it unnecessary to push all of the code needed for the network system every time it needs to be updated. The fact that the service broker needs to be removed and replaced during the update still means that there will be a period of time when the system cannot process service requests because the system will have no way to deal with a critical portion of the processing. If the service requests cannot reach the requested services, it doesn't matter whether or not the service is there or not. Finally, even though only a service broker and additional service need to be pushed in router based systems, the slightest improvement in the size of a code push can have a dramatic impact on the time it takes to update a system because most modern systems are served by a multitude of servers spread out over a global network. Saving one second may not mean much to a system having one server, but if a thousand servers are needed, that same update will result in more than 15 minutes of lost processing time.

Embodiments of the present invention deal with the drawbacks described above through the deployment of a flexible modular account engine. Each access channel to the system is treated as a discrete modular element with its own adaptor used to translate the contents of that channel into a canonical format that is comprehensible to the overall system. Each service provided by the account engine is likewise treated as a distinct and modular element. As a result, the number of services provided by the account engine can be modified at will by the operator of the engine. Also, the manner in which additional channels and services can be added to the system is conducted in such a way that there is no interruption to the service provisioning system without the need for additional hardware to implement the system.

Embodiments of the present invention are particularly suited for service provisioning systems such as account engines for financial institutions. Since the system is modular in terms of the channels that can be used to access it, financial institutions that are enabled by the account engine can set their own levels of encryption for accessing the system. For example, many payment processors require a certain degree or type(s) of encryption between a point of sale terminal and the servers where the payment is processed. Since different payment processors have their own proprietary systems, many of these requirements are technologically incompatible. Therefore, an account engine with modular access channels is beneficial because it allows the payment service provider to accommodate the needs of a large number of financial institutions with which it does business with only a minimum modification to the code necessary to implement the system.

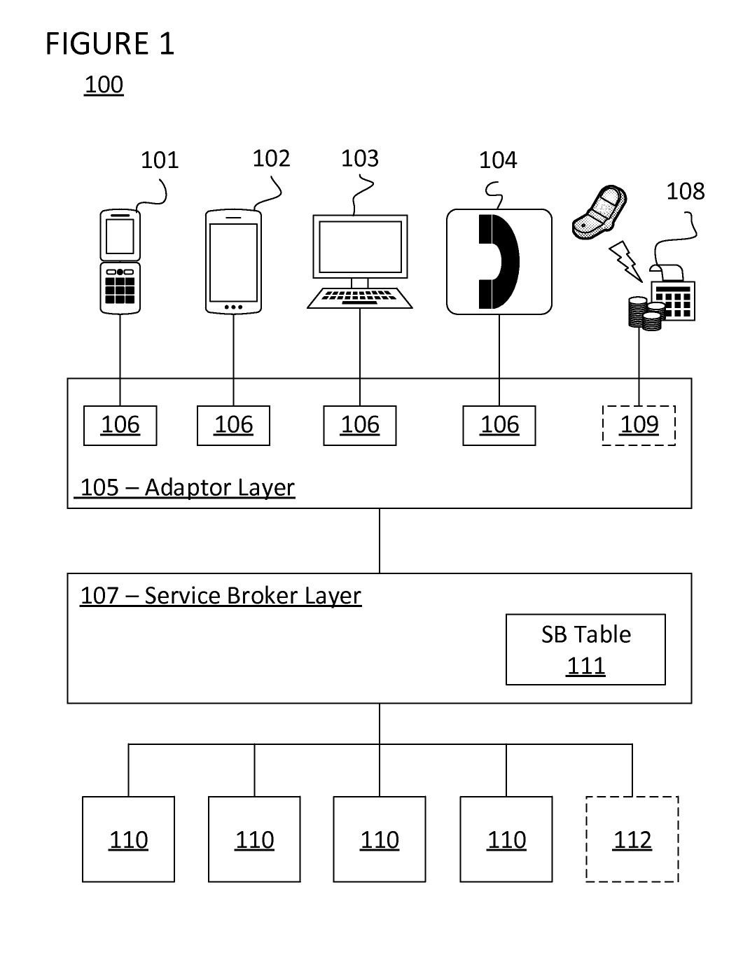

FIG. 1 displays an account management engine 100. The account management engine 100 provides service access functionality for a payment system. The account management engine 100 provides access to services via several channels such as SMS 101, a native smart phone and/or tablet application 102, a web portal 103, and/or an interactive voice response system 104. The systems requesting access through these channels can be referred to as request clients. Any number of other channels could be used to access account management engine 100. For example, a point of sale terminal (POS) terminal could be used by a merchant and a purchaser to access the account management engine 100 and to administrate a transfer of funds between the purchaser and the merchant. Regardless, any of the channels could be used to access the account management engine 100 via an adaptor layer 105. The adaptor layer 105 could be a module running on one or more servers in one or more datacenters on behalf of one or more payment services. The adaptor layer 105 comprises numerous discrete translation adapters 106. These translation adaptors 106 can also be called request handlers. Each channel used to access payment engine 100 could include its own discrete translation adaptor 106 to normalize the data request and turn it into a canonical data format that can be operated on by a downstream module in the account management engine 100.

Adaptor layer 105 yields numerous benefits. A server that is instantiating adaptor layer 105 can receive a stream of service requests from various request clients. Each request handler in the system can have its own independent uniform resource locator (URL), and the request clients can use the uniform resource locator for a corresponding discrete adaptor 106 such that the stream of service requests can be parsed to be independently received by separate discrete adaptors 106. The service requests can therefore be independently routed to discrete adaptors 106 in adaptor layer 105 where data corresponding to each service request is translated into a canonical data format which is a common internal format for deeper layers of the system. For example, in a system using JSON as the canonical data format, discrete adaptor 106 for a POS client can receive a service request in ISO 8583 format over TCP/IP and can translate it into JSON according to any JSON Schema. As another example, discrete adaptor 106 for an SMS client may receive a service request in XML format over HTTP and translate it into JSON according to any JSON Schema.

If the payment service wants to introduce a new access channel 108 to the system, such as one using near field communication (NFC) client, then the system can be modified to accommodate the new access channel by adding a new discrete adaptor 109. A new discrete adaptor 109 can be added from a code repository of the payment service that is in communication with the server that instantiates adaptor layer 105. The new discrete adaptor 109 can be added to adaptor layer 105 while the other discrete adaptors 106 are still processing the stream of requests pouring in from the external network. Therefore, because the remainder of the deeper levels of the system are agnostic to the channel on which a request is received, new channels can be added without needing to update the rest of the system, and the server can add new discrete adaptor 109 to adaptor layer 105 to accommodate new access channel 108 without interrupting the stream of service requests being received from the external network along any of the older channels 101-104.

After service requests are translated into a canonical data format, the requests are routed to service broker layer 107. Service broker layer 107 could be a module running on one or more servers in one or more datacenters. At this point, all channel-specific protocol and data formats will have been normalized in the adaptor layer 105. Service broker layer 107 can route the normalized service requests to one or more appropriate services 110 based on service(s) identified in the normalized service requests. Service broker 107 layer can route the normalized service requests using service broker lookup table such as service broker lookup table 111. Service broker lookup table 111 includes a set of entries that will be described in more detail below. Services 110 can include any service provided by an account-based online system. For example, a service 110 can include a business feature of a payment service such as an add money service, a POS purchase service, a balance query service, a withdraw money service, a request money or push payment service, a peer-to-peer send money service, etc.

The benefits of using service broker layer 107 are better understood with reference to the operation of service broker layer 107 during the introduction of a new service such as new service 112. When the payment service responsible for administrating account management engine 100 is ready to roll out new service 112, a new entry will be added to service lookup table 111. Data in service requests can be looked up in service broker lookup table 111 in order to be routed to the appropriate service 110. The server broker lookup table 111 could, for example, contain a list having entries for all the services 110 offered by account management engine 100 and having corresponding entries for the addresses or endpoint uniform resource locator of those services 110. Therefore, adding a new entry to service broker lookup table 111 for new service 112 can allow future requests for new service 112 to be routed using the proper address or URL. The remainder of service broker lookup table 111 can remain unmodified and stand ready to continuously route the stream of received service requests without interruption.

New service 112 can be any type of new or existing service. For example, new service 112 could be a withdrawal limit adjustment service. However, new service 112 could also be a service that is already offered in some form by services 110. In other words, new service 112 could be a different version of one of services 110, such as a customized version of one of services 110 that is customized for a particular financial institution or user. For example, the new service could be a send money service in combination with an overdraft protection feature that would pull funds from a secondary source if a primary source associated with the send money feature did not have enough funds to execute a transaction. This modularity could be particular useful in situations where certain financial institutions were already offering a send money service among the services 110, but a particular financial institution wanted to offer the overdraft protection feature to its own customers. The different version can also be an upgrade of a service 110 that fixes bugs, offers enhancement requests, and/or prepares the service for future upgrades.

The servers utilized to instantiate adaptor layer 105, service broker layer 107, and services 110 can take on various configurations. The servers can each be a single physical unit or a virtual server powered by multiple networked physical devices. The servers could supplement the provided services with data pulled from a central database used by the payment system and may also require additional processing resources from other servers or processing devices in communication with the servers. The servers could be similar to the MOBI account server, described in U.S. Patent Publication No. 2009/0024533 A1 for “Payment Systems and Methods” filed Aug. 29, 2007, or U.S. patent application Ser. No. 13/755,421 for “Self-authenticating peer-to-peer transaction” filed Jan. 31, 2013, both of which are owned by the assignee of the present invention, and both are incorporated by reference herein in their entirety. The various components including layers, adaptors, services, repositories, tables, and databases can be stored on non-transitory computer-readable media as source code, machine code, or a combination of the both.

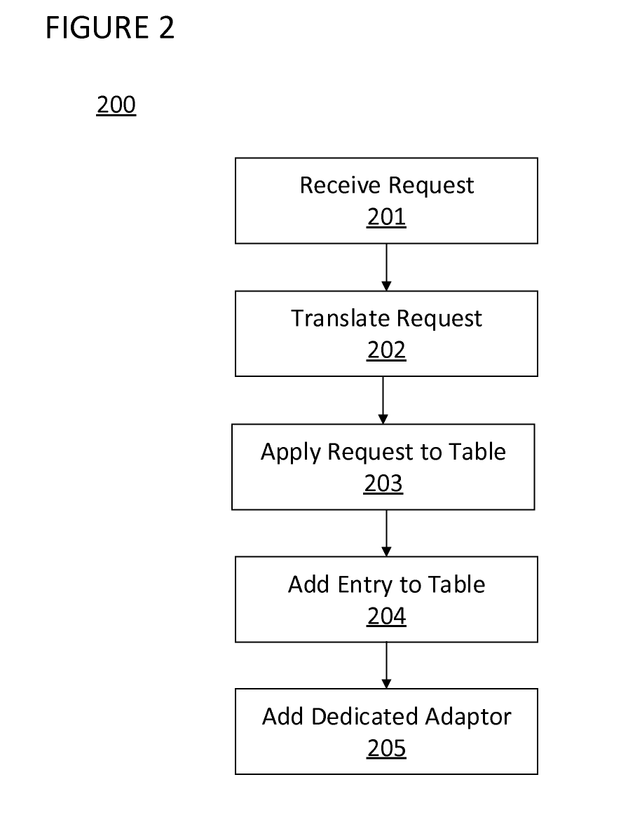

FIG. 2 illustrates a process 200 by which a system (such as what is illustrated in FIG. 1) can add additional services and access channels without interrupting the system. In step 201, a service request is received by the system in an external channel format. In step 202, the service request is translated from the external channel format into a common internal system format using a dedicated adaptor on a server. For example, the request could be translated from an SMS message and translated to a format used to pass requests and responses within a payment processing system. In step 203, data of the translated service request is looked up in a service lookup table. In step 204, the service lookup table is updated by adding an entry to the service lookup table having a service lookup table format that identifies the translated service request. The applying step 203 and the adding step 204 can overlap or occur concurrently because the remainder of the service lookup table can still be accessed when an additional entry is being added. Furthermore, the service lookup table may use an identical nomenclature to the internal system format such that a service broker using the service lookup table only needs to identify which portion of the request identifies the requested service in order to match the service request with the appropriate address at which a service is provided. The process in FIG. 2 can optionally include an additional step 205 of adding a dedicated adaptor to the server. The step 204 of adding the entry to the service lookup table and the step 205 of adding the dedicated adaptor can overlap or occur concurrently with any other step.

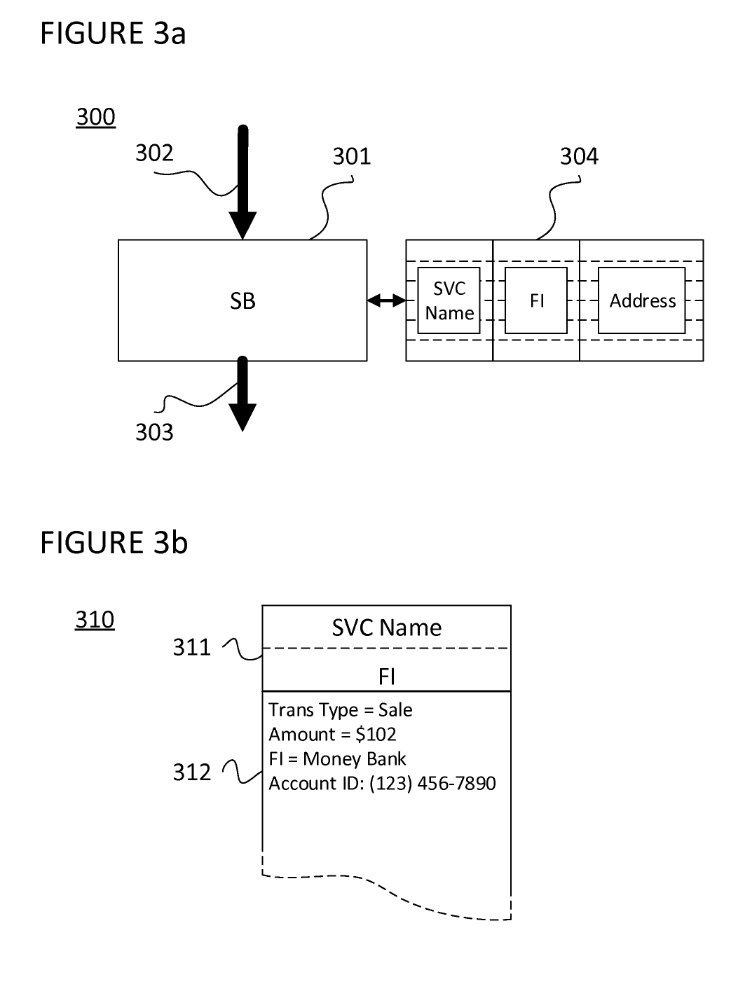

An exemplary operation of a service broker table can be described with reference to FIGS. 3a and 3b. FIG. 3a shows an operational diagram 300 of service broker lookup table. Service broker lookup table 111 in FIG. 1 could operate in accordance with this diagram. Service broker processor 301 receives service requests 302 and returns addresses 303. Service requests 302 can be received from an adaptor layer after having been normalized to a canonical format. Service broker processor 301 has access to lookup table 304. As drawn, lookup table 304 has three columns. A service name column and a financial institution column can be used to match identifiers provided by service requests 302. For example, if service request 302 was for a send money transaction involving financial institution Money Bank, the service request could include the text “SEND_MONEY” and the identifier “MBnk,” and the combination of those two data segments could match one or more entries in lookup table 304. In this way, different versions of the same service can be accessed depending upon the financial institution involved in the transaction. The relationship of the financial institution to the particular service and its address in lookup table 304 could be updated periodically from a financial institution configuration database. Service broker processor 301 could lookup and return the address in lookup table 304 corresponding to the matching entry and return the address as address return 303. The address could include an endpoint uniform resource locator for the service.

Lookup table 304 can have several variations. As an example, lookup table 304 could include entries for a financial institution associated with the transaction and could also include entries for a user of the payment service associated with the transaction. The column for the financial institution in lookup table 304 could be replaced with version numbers of particular services, or lookup table 304 can additionally include a column for storing the version numbers of the services. As another example, lookup table 304 could also include a basic set of two columns with an entry for a service name and an entry for the address. This type of approach wouldn't foreclose the existence of multiple versions of the same service since the version number could be built in to the service name in a single entry in lookup table 304, for example, appended to a string corresponding to the service name. As another example, it would also be possible to include a null value in the columns matched by data in the service request 302. A null value could indicate that a user was requesting a default version of a particular service (e.g., a version number field is null) or a default service offered by the system (e.g., a service name field is null). As another example, lookup table 304 could be instantiated in memory in any kind of linked data structure such as a NoSQL or in-memory database. For example, the address could be stored in a service metadata cache that is continuously updated to reflect the condition of the services offered by the engine as they exist in memory as long as the address was in some way detectibly affiliated with a canonical identifier for the service.

FIG. 3b illustrates an example of a service request 310 that has been normalized by the adaptor layer. The service request 310 comprises a header, such as header 311, and a body, such as body 312. Header 311 can be configured to include all the information required to lookup an address in lookup table 304 such that service broker processor 301 only needs access to header 311 to conduct a lookup—although header 311 may contain null values for certain columns as mentioned previously. Body 312 of service request 310 can include data used by individual services, such as individual services 110, to conduct operations offered by those services. Body 312 of service request 310 may not need to be accessed by service broker processor 301 in order for service request 310 to be routed to an address of an intended service and can therefore be service-specific.

The service request 310 can be transmitted in accordance with the JSON format. For example, the body 312 may be a transfer money request that identifies a transaction as a sale involving a transfer of $102 from an account identified by an account holder's mobile phone number to an account held at the financial institution Money Bank. The JSON-formatted service request 310 could appear as follows:

```
{
      “header”: {
            “svcName”: “transfer money”,
            “FI”: “Money Bank”
      },
      “body”: {
            “transType”: “sale”,
            “amount”: 102.00,
            “FI”: “Money Bank”,
            “accountID”: “(123) 456-7890”
      }
}
```

The body could also identify a particular version of the service being requested and include an offset for the address that would be provided by the lookup table. The different versions of the service being requested could be stored sequentially in logical memory such that they could be accessed from a single root address. As long as the service name in header 311 properly identifies service request 310 as a transfer money request, service broker processor 301 can route service request 310 to the corresponding address regardless of the contents of body 312.

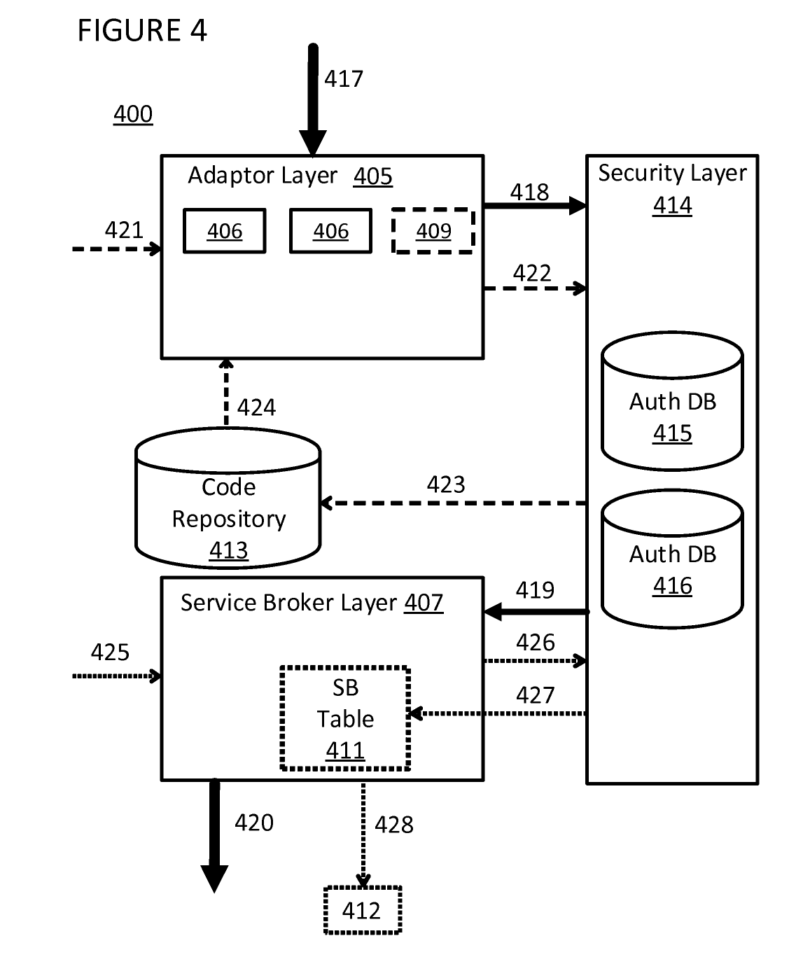

FIG. 4 illustrates a block diagram of system 400 that includes many of the features of account management engine 100, and further includes a modular security feature. In system 400, adaptor layer 405 receives a stream of service requests 417 in one or more external channel formats. Adaptors 406 translate the service requests into a common internal system format—the service requests can then be considered normalized. Instead of sending a normalized service request directly to service broker layer 407, adaptor layer 405 can send normalized service request 418 to security layer 414. Security layer 414 can perform any number of security methods on the normalized service request.

As one example of a security method, security layer 414 can read authentication data from normalized service request 418 and lookup the authentication data in authentication database 415 to determine whether a request client associated with the normalized service request is authenticated to access the payment service. To do so, security layer 414 can read an account ID and password from the normalized service request. The password can be extracted from the normalized service request in an encrypted format and decrypted by the security layer using a private key, or the password can be extracted from the normalized service request in a hashed format (e.g., using SHA-2 to ensure or minimize hash collisions) and compared to a hashed password corresponding to the account ID such that authentication can be performed without ever storing the password in plaintext.

As another example of a security method, security layer 414 can read authorization data from the normalized service request and lookup the authorization data in authorization database 416 to determine whether the request client associated with the normalized service request is authorized to use a requested service. To do so, the security layer 414 can read an account ID from the normalized service request and lookup the account ID in authorization database 416 to determine whether the request client is authorized to use the requested service.

If security layer 414 determines that the request client is not authenticated or not authorized, security layer 414 can respond to the requesting client through adaptor layer 405 or other presentation layer component (not shown) and refrain from forwarding the normalized service request to service broker layer 407. If security layer 414 determines that the request client is authenticated and authorized, security layer 414 can forward normalized service request 419 to service broker layer 407, and service broker layer 407 can determine where to send normalized service request 420.

The security layer 414 can also perform security methods with respect to registration of new adaptors and new services. To add a new adaptor or update an existing adaptor, a new adaptor requestor (not shown) sends new adaptor request 421 to adaptor layer 405. Instead of adding the new adaptor directly to code repository 413, adaptor layer 405 can optionally normalize new adaptor request 421 and can send new adaptor request 422 to security layer 414. Similar to the other security methods (e.g., authentication and authorization) described herein, security layer 414 can perform any number of security methods on the new adaptor request (e.g., by accessing authentication database 415 and/or authorization database 416 to authenticate and/or authorize the new adaptor request). If the security methods pass and the new adaptor request includes adaptor code to be added to code repository 413, security layer 414 can add adaptor code 423 directly to code repository 413. Alternatively, security layer 414 can respond to adaptor layer 405, which can then add adaptor code 423 to code repository 413. If the security methods pass and the new adaptor request does not include the adaptor code, security layer 414 can respond to adaptor layer 405, which can then respond to the new adaptor requestor by requesting more information such as the adaptor code itself. After the adaptor code is added to code repository 413, adaptor layer 405 can access code repository 413 for adaptor code 424 to instantiate a new adaptor 409.

To add a new service or update an existing service in accordance with an added security method, a new service requestor (not shown) sends service update request 425 to service broker layer 407. Instead of adding the new service directly to service broker lookup table 411, service broker layer 407 can send service update request 426 to security layer 414. Similar to the other security methods (e.g., authentication and authorization) described herein, security layer 414 can perform any number of security methods on service update request (e.g., by accessing authentication database 415 and/or authorization database 416 to authenticate and/or authorize the service update request). If the security methods pass and the service update request includes service data to be added to service broker lookup table 411, security layer 414 can add service data 427 directly to service broker lookup table 411. Alternatively, security layer 414 can respond to service broker layer 407, which can then add the service data to service broker lookup table 411. If the security methods pass and the service update request does not include the service data, security layer 414 can respond to service broker layer 407, which can then respond to the new service requestor requesting more information including the service data. After the service data is added to service broker lookup table 411, service broker layer 407 can access service broker lookup table 411 to route normalized service requests 428 to new service 412.

Additional flexibility is provided for some of these security methods by keeping the authentication database 415 and authorization database 416 as logically separate elements from other data and components. Authentication and authorization data can be updated on-the-fly concurrently with other operations of the system without interrupting those functions. Further, because security layer 414 is transparent to request clients and services, security layer 414 can be more easily upgraded, scaled, and maintained. Security layer 414 can accommodate other security methods instead of or in addition to those mentioned above. For example, adding an LDAP-based accounting security method to authentication and authorization security methods can yield an AAA Layer.

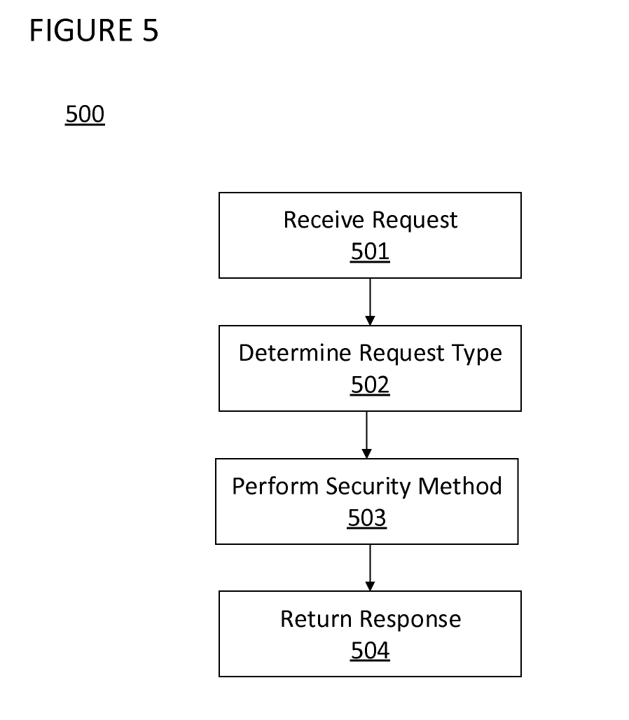

FIG. 5 illustrates a flow chart of a method 500 for processing requests sent to a security layer. At step 501, the security layer receives a request. At step 502, the security layer determines the request type of the request. In accordance with disclosed examples, the request type can be one of a service request, a new adaptor request, an adaptor update request, a new-service request, and a service update request. At step 503, based on the request type, the security layer can perform varying security methods on the request. In accordance with disclosed examples, the security methods can include an authentication method, an authorization method, an accounting method, or any other security-based method. At step 504, the security layer has completed the security method(s) and can return a response based on the security method(s) performed and the request type.

Although embodiments have been discussed primarily with respect to specific embodiments thereof, other variations are possible. Various configurations of the described system(s) may be used in place of, or in addition to, the configurations presented herein. Those skilled in the art, upon attaining an understanding of the foregoing, may readily conceive of alterations to, variations of, and equivalents to these configurations, and will appreciate that the foregoing description is by way of example only, and is not intended to limit the present disclosure. For example, nothing in the disclosure should be read to limit the system to a payment processor as any network-based system that is capable of providing multiple services through multiple channels can benefit from the teachings disclosed herein. In general, the diagrams presented are only intended to indicate one possible configuration, and many variations are possible. Those skilled in the art will also appreciate that methods and systems consistent with the present disclosure are suitable for use in a wide range of applications encompassing any related to payment processing or providing back end services to any account engine regardless of that account's relationship to payment processing or finance. Thus, these and other modifications and variations to the present disclosure may be practiced by those skilled in the art, without departing from the spirit and scope of the present invention(s), which is/are more particularly set forth in the appended claims.

What is claimed is:

1. An account management system comprising:
an adaptor layer having a set of server-instantiated discrete adaptors, each of the discrete adaptors receiving a stream of service requests in an external channel format that is specific to a particular discrete adaptor, and the discrete adaptors translating the service requests from the external channel format to a common internal system format to generate a stream of normalized service requests;
a service broker layer that receives the stream of normalized service requests in the common internal system format and parses the normalized service request for service request lookup data;
a service lookup table for providing a service address in response to the service request lookup data; and
a code repository storing one of: (i) code for a new discrete adaptor, and (ii) a new entry for the service lookup table corresponding to a new service.

2. The account management system of claim 1, wherein
the common internal system format includes a header that identifies a service using a nomenclature identical to a nomenclature used in the service lookup table.

3. The account management system of claim 1, wherein
a service request in the stream of service requests is selected from a group consisting of a send money request, a balance inquiry request, and an add money request.

4. The account management system of claim 1, wherein
the adaptor layer can transparently add the new discrete adaptor to the set of server-instantiated discrete adaptors such that no other modifications are required to the system to process service requests from an external channel corresponding to the new discrete adaptor.

5. The account management system of claim 1, wherein
the system stores both code for the new discrete adaptor and the new entry for the service lookup table corresponding to the new service.

6. The account management system of claim 1, wherein
the service lookup table can simultaneously: (i) provide the service request lookup data to the service broker layer, and (ii) receive the new entry from the code repository.

7. The account management system of claim 6, wherein
the new service is an updated version of an existing service.

8. The account management system of claim 1, further comprising:
a security layer configured to receive the stream of normalized service requests from the adaptor layer, perform a security method based on the content of each normalized service request in the stream of normalized service requests, and send a subset of the stream of normalized service requests to the service broker layer based on an outcome of the security method.

9. The account management system of claim 8, wherein
the security method includes reading authentication information from the normalized service requests and querying an authentication database using the authentication information.

10. The account management system of claim 9, wherein
the security method further includes reading transaction information from the normalized service requests and determining whether the requesting clients are authorized to perform requested transactions based on the transaction information by querying an authorization database.

11. A computer-implemented method comprising:
receiving a service request using a discrete adaptor, where the service request has an external channel format that is specific to the discrete adaptor, where the service request requests a service, and where the discrete adaptor is instantiated on a server;
translating the service request from the external channel format into a common internal system format using the discrete adaptor, where the discrete adaptor is dedicated to the specific external channel on which the service request was received;
parsing the service request in the common internal system format in a service broker layer to obtain service request lookup data from the service request;
looking up the service request lookup data in a service lookup table to retrieve a service address; and
updating the service lookup table by adding an entry to the service request lookup table, the entry having a service lookup table format;
wherein at least part of the lookup step and at least part of the updating step occur simultaneously; and
the common internal system format and the service lookup table format use an identical nomenclature to identify the service.

12. The computer-implemented method of claim 11, further comprising:
adding a new discrete adaptor to the server from a code repository.

13. The computer-implemented method of claim 11, wherein
adding a new entry to the service lookup table corresponding to a new service.

14. The computer-implemented method of claim 11, further comprising:
the service request is selected from the group consisting of a send money request, a balance inquiry request, and an add money request.

15. The computer-implemented method of claim 11, further comprising:
transparently adding the new discrete adaptor to the server such that no other modifications are required to process service requests from an external channel corresponding to the new discrete adaptor.

16. The computer-implemented method of claim 11, wherein
the entry corresponds to an updated version of an existing service identified in the service lookup table.

17. The computer-implemented method of claim 11, further comprising:
receiving, in a security layer, the service requests in the common internal system format from the discrete adaptor;
determining, in a security layer, the request type of the service request;
performing a security method on the service request based on the request type;
returning a response to an alternative presentation layer component from the security layer if the security method determines that the request is not authenticated and authorized; and
forwarding the service request to the service broker layer to be parsed from the security layer if the security method determines that the request is authenticated and authorized.

18. The computer-implemented method of claim 17, wherein
the security method includes reading authentication information from the normalized service requests and querying an authentication database using the authentication information.

19. The computer-implemented method of claim 18, wherein
the security method further includes reading transaction information from the normalized service requests and determining whether the requesting clients are authorized to perform requested transactions based on the transaction information by querying an authorization database.

20. An system comprising:
a set of server-instantiated request handlers, each request handler receiving a stream of service requests in an external channel format, and each request handler having a unique associated uniform resource locator;
an adaptor layer having a set of server-instantiated discrete adaptors, the discrete adaptors translating the service requests from the external channel format to a common internal system format to generate a stream of normalized service requests;
a service broker layer that receives the stream of normalized service requests in the common internal system format and parses the normalized service request for service request lookup data;
a service lookup table for providing a service address in response to the service request lookup data; and
a code repository storing one of: (i) code for a new discrete adaptor, and (ii) a new entry for the service lookup table corresponding to a new service;
wherein the service lookup table can simultaneously: (i) provide the service request lookup data to the service broker layer, and (ii) receive the new entry from the code repository; and
the adaptor layer can transparently add the new discrete adaptor to the set of server-instantiated discrete adaptors such that no other modifications are required to the system to process service requests from an external channel corresponding to the new discrete adaptor.
